(19) United States
(12) Patent Application Publication
(10) Pub. No.: US 2005/0268525 A1
(43) Pub. Date: Dec. 8, 2005

(54) Bait holding system

(76) Inventor: Graham Kalazich, Elanora Heights (AU)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(21) Appl. No.: 10/505,310

(22) PCT Filed: Feb. 21, 2003
(86) PCT No.: PCT/AU03/00226

§ 371 Date: Apr. 20, 2005

(30) Foreign Application Priority Data
Feb. 22, 2002 (AU) PS 0718
Mar. 25, 2002 (AU) PS 1343

(51) Int. Cl. A01K 83/06

(52) U.S. Cl. 43/41; 43/42.06; 43/44.4

(57) ABSTRACT

A bait holding apparatus (20, 140) includes a deformable receptacle (20, 140) into which the bait (F) can be placed such that the receptacle (20, 140) can deform around the bait (F). A plurality of apertures (22, 158) are defined in the receptacle (20, 140) such that, when the bait (F) is placed therein, the predator can sense the bait (F) via the apertures (22, 158). The apparatus (20, 140) can have a shape that enables it to surround the bait (F) in a close-facing relationship. Alternatively, the apparatus (140) can be a plurality of interconnected ties (142). A method for forming the apparatus (20) includes the steps of dipping a mandrel into molten material for the sleeve; removing the mandrel and allowing the sleeve to solidify around the mandrel: forming a plurality of apertures in the sleeve, either whilst on the mandrel, or once removed therefrom.

### FIELD OF THE INVENTION

The present invention relates to a bait holding system developed primarily, though not exclusively, for holding and optionally reinforcing, storing or housing bait for use in fishing and related pursuits. However, the system can also be applied in other applications where bait is employed, such as hunting, trapping etc.

### BACKGROUND TO THE INVENTION

In both commercial and recreational fishing, bait disintegration can be a problem where the bait is subjected to successive hits, grabs or strikes, or where the bait is suspended in water for considerable periods of time.

In deep-sea fishing for large fish, such as billfish (including marlin), it is known to use “teasers” to attract the fish into the vicinity of a fishing vessel. Artificial teasers only work if the fish visually sights the teasers and therefore natural teasers have been employed because of the fish-attracting aroma and scent they release in addition to appearance. Where natural teasers are used, again the problem of disintegration becomes an issue.

It is known to reinforce natural teasers, such as whole fish (eg slimy mackerel), by wrapping or stitching the bait with thread. However, the preparation of each teaser is very time consuming, often taking from 10 to 30 minutes and, where multiple teasers are used, this can involve significant preparation time and delays.

In non-water based applications of bait, such as with hunting or trapping, baits are often used to lure predators, which may be game or pests. Again, baits can disintegrate when left out in the environment for some time, or when subjected to successive nibbling, biting or feeding by a predator. They may also disintegrate without, for example, the associated trap being activated.

Mesh bags for surrounding bait on a fishing hook are known in the art. Examples are shown in U.S. Pat. No. 4,839,982, U.S. Pat. No. 6,427,260, NZ241883, GB2310782, WO96/28021 and DE3439735. Whilst these apparatus can also act as teasers, because fish-attracting aroma and scent can be released therefrom, the apparatus are not designed to enhance visual attraction, in that they retain essentially a bag shape once bait has been inserted therein.

U.S. Pat. No. 2,828,571 discloses a sleeve holder for live bait. The sleeve has an open lower portion defined by spaced apart sides, with a reinforcing strip being employed to close the lower portion. This makes manufacture of the sleeve quite complex. U.S. Pat. No. 2,780,021 discloses a bait bag formed from two halves sealed together along a seam. Again, the manufacture of the bag is rendered more complex.

### SUMMARY OF THE INVENTION

In a first aspect the present invention provides a bait holding apparatus comprising:
a resiliently deformable receptacle having an open end and an opposing closed end, the bait being insertable into the receptacle through the open end and, once inserted, the receptacle being resiliently deformable around the bait, the receptacle extending seamlessly around the closed end and lateral side(s) thereof; and
a plurality of apertures defined in the receptacle such that, when the bait is placed therein, a predator can sense the bait via the apertures.

Employment of a deformable receptacle enables the apparatus to assume the shape of the bait. This is advantageous where the bait is a whole small animal, such as a small baitfish or rodent, as a predator can still recognise the animal shape. However, where the bait is fragments such as chopped up bait, the receptacle can be shaped to simulate a whole small animal, and the bait can then be urged therein such that the receptacle still deforms around the bait, and assumes the shape of the small animal.

Advantageously, the apparatus of the present invention provides a receptacle which deforms around the exterior of the bait to contain it, whilst also enabling it to be rapidly and easily reinforced. in addition, the employment of a plurality of apertures allows the predators to more easily sense the bait, and optionally access it.

Preferably the receptacle is a sleeve into which the bait can be inserted. The employment of a sleeve is extremely convenient because of its case of use. Preferably the sleeve is elongate. Preferably the open end is reinforced to enhance bait introduction into the receptacle. This arrangement provides for a rapid deployment of the bait.

Preferably the apertures are a plurality of holes formed in the receptacle to define a generally perforated or grid-like formation around the bait in use. This maximises the exposure of the bait whilst still reinforcing it, and enables its taste, aroma, scent, shape and visual qualities to be preserved.

Preferably the closed end is adapted for providing a line attachment point thereto. Thus, the bait reinforcing apparatus can be attached to a connecting line such as a fishing line, so that it may be reused. In land-based applications the apparatus can be connected to a safety line.

Optionally, hooks or other fastening mechanisms can be associated with the apparatus so that it can function not only as an attractor, but also as a captive mechanism. Other attractor accessories can also be associated with the receptacle such as coloured nose cones, side flippers and fins, beaks, noses etc.

The closed end can be provided with an aerodynamic profile to enhance movement of the apparatus through a fluid such as water.

In a second alternative aspect, the apparatus can comprise a plurality of optionally deformable rings in series through each of which the bait can be inserted, with each ring connected to a next adjacent ring by one or more connecting members. Each ring can define a lateral side of the receptacle. Preferably in this regard the bait is inserted to extend through each of the rings in series, with preferably two connecting members maintaining the rings in spaced relation to each other and preventing, for example, their displacement too far from each other, thereby maintaining the integrity of the apparatus.

Typically the receptacle is formed form an elastomeric material having shape memory, such as a polymeric rubber. In this regard, the material may also be impregnated with colourings and other attractor features such as reflective material fragments including metal fragments etc.

In a third aspect the present invention provides a method for forming a bait holding apparatus where the receptacle is a sleeve as defined in the first aspect, comprising the steps of:
dipping a mandrel into molten material for the receptacle;
removing the mandrel and allowing the receptacle to solidify around the mandrel;
forming a plurality of apertures in the receptacle whilst on the mandrel or once removed therefrom.

The receptacle closed end can be defined at the free end of the mandrel and can be additionally formed to take appropriate shapes and receive attachments as described above.

The opposite open end of the receptacle can be formed around the mandrel, for example, by being folded or rolled over prior to complete solidification, to define a reinforcement around the open end, thus allowing for repeated insertion of bait thereinto without tearing at the open end.

Preferably the apertures are formed in the sleeve by pressing, punching or cutting. The apertures may also be formed by appropriate protrusions defined on the mandrel.

In a fourth aspect the present invention provides a method for forming an apparatus as defined in the second aspect where the receptacle includes a plurality of deformable rings, comprising the steps of:
arranging a sheet of deformable material on a substrate; and
forming in and then removing from the sheet a plurality of adjacent but non-overlapping rings, such that at least one connecting member extends between adjacent rings.

Advantageously in the fourth aspect the apparatus can be formed using a single pressing, punching or cutting motion thus providing for rapid apparatus manufacture. Alternatively, the rings and connecting member(s) can be moulded.

Preferably two connecting members are defined to extend between adjacent rings, one being tangential to an upper part of each ring and the other being tangential to a lower part of each ring.

In a fifth aspect, the present invention provides a bait holding apparatus formed from a material having a plurality of apertures therethrough that has a shape that enables it to be positioned to surround the bait in a close facing relationship, in a manner that tends to preserve the structural integrity of the bait. This apparatus can comprise the apparatus as defined in the first or second aspects. Alternatively the apparatus can comprise a metallic mesh receptacle (eg. a perforated or apertured stainless steel mesh bag including eg. wire mesh) that is shaped for positioning in a close facing relationship to the bait (especially a whole bait). As a further alternative, the apparatus can be in the form of ties or tapes (eg. an adhesive tape) having apertures therethrough and which can be wrapped around the bait in the close facing relationship.

The ties or tapes can be arranged in a grid formation for wrapping around the bait, the grid defining the apertures therethrough with free ends of the ties or tapes being fastened altogether to define the receptacle.

In a sixth aspect the present invention provides a bait holding apparatus comprising:
a receptacle in which the bait can be held and including an opening through which the bait can be introduced into the receptacle; and
a closure for the receptacle opening and about which the receptacle can be releasably attached to close the opening.

Advantageously the sixth aspect of the invention provides a rapid and secure closing system. The closure may also provide a supporting substrate for the attachment of lines and/or hooks to the apparatus (e.g. when used in fishing).

Preferably the closure has one or more passages extending therethrough such that fluid can flow from the apparatus exterior and into the receptacle interior. For example, when used in water, water may be caused to flow through the passages). Advantageously, when the receptacle is porous or apertured, fluid can flow right through the apparatus, especially where a line is attached to the closure and the closure is pulled through water. This would cause water to flow through the apparatus via the passages, then through the pores/apertures of a receptacle. This has particular advantages in fishing as described below.

Preferably the closure is a bung having a peripheral recess defined at one end thereof into which a skirt portion of the receptacle opening can be releasably fastened In this regard, the skirt portion can be retained in the recess by a the or ring extending circumferentially there around (e.g. a polymeric O-ring).

Optionally, attractor devices can be associated with the closure, and these can include filaments attached thereto and which extend away therefrom when the apparatus is dragged through water. Such attractor devices can also include apparatus colouring, imaging such as eyes, reflectors, reflective material dispersed through the closure etc.

The receptacle of the sixth aspect may also be as defined as in the first or fifth aspects, or manufactured using a method according to the third aspect.

In a seventh aspect the present invention provides a bait holding apparatus comprising:
a receptacle in which the bait can be held and including an opening through which the bait can be introduced into the receptacle; and
a closure for the receptacle opening and having one or more passages extending therethrough such that fluid can flow from the apparatus exterior and into the receptacle interior.

A flow of fluid, such as water, through the apparatus can enhance/increase the release of aroma, scent and bait particles to the environment to attract predators.

The receptacle of the seventh aspect may also be as defined in the first, fifth or sixth aspects, and typically the closure is as defined in the sixth aspect.

In an eighth aspect the present invention provides a bait holding apparatus comprising a plurality of ties, each tie connected to one or two adjacent ties and each having a fastening mechanism associated with opposite ends thereof such that each tie can be wrapped around the bait and then fastened at or near its ends.

Such a system provides an alternative to inserting the bait into a receptacle, such as a sleeve, and provides a rapid means for reinforcing a bait.

Preferably each tie is connected to one or two adjacent ties by one or more transversally extending ties, to define a tie grid. In his regard, each transversally extending tie can be insertable through a respective slot in each of the plurality of ties, providing adjustability to the overall grid formation. Also, preferably each transversally extending tie is interferingly receivable in its respective slot in each of the plurality of ties, thus providing dimensional stability to the tie grid.

The fastening mechanism can be embodied as:
free tie ends that can be tied together to fasten the apparatus to the bait; or
a slotted bead at one tie end and a free end at the other end that is receivable interferingly through the slot of its bead to fasten the apparatus to the bait.

Preferably sides of the other tie free end, or of each transversally extending tie, are serrated. This facilitates their interfering receipt within respective slots,

Each tie can be provided in the form of a flat tape-like member, or can be a member which is generally circular in cross-section. Each tie may also be formed from an elastomeric material.

In a ninth aspect the present invention provides an applicator for a bait holding apparatus that includes a deformable opening to a receptacle, the applicator also being suitable for apparatus as defined in the first, second, fifth, seventh or eighth aspects, the applicator comprising a receptacle insertion end adapted for insertion into an opening of the receptacle to deformably open the same to facilitate bait insertion, and a bait guiding surface extending from the insertion end and over which the bait can be moved, with the surface extending towards an applicator remote end for protruding beyond the receptacle when the applicator is inserted in the receptacle opening to facilitate applicator handling by a user.

This applicator further enhances the use of bait holding apparatus in accordance with the present invention, easing and speeding up the insertion of bait into the apparatus.

Preferably the applicator is generally flat and, in plan view, gradually tapers from a relatively wider remote end to a relatively narrower insertion end, with the bait guiding surface being defined on either side of the applicator. Alternatively the bait guiding surface can be concave.

Preferably one or more guide channels are provided on the bait guiding surface to facilitate guidance of the bait towards and in through the receptacle opening.

Optionally one or more finger holes are provided at the remote end to facilitate user handling of the applicator.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 shows a perspective view of a first bait holding apparatus in accordance with the present invention;

FIG. 2 shows a side elevation of an alternative apparatus to that shown in FIG. 1, with a bait inserted therein;

FIG. 3 shows a similar view to FIG. 1, but with a closed end of the apparatus being modified for line attachment and for water movement;

FIG. 4 shows a similar view to FIG. 2, but with a closed end of the apparatus being again modified for line attachment and for predator attraction;

FIG. 5 shows an apparatus similar to that of FIG. 2, but modified with an attractor element attached thereto;

FIG. 6 shows a plan elevation of an alternative bait holding apparatus;

FIG. 7 shows a side elevation of the apparatus of FIG. 6 when fitted to a bait;

FIG. 8 shows a side elevation of a further alternative bait holding apparatus when fitted to a bait;

FIG. 9 shows a side elevation of an extruded elastomeric mesh material suitable for use with various apparatus according to the present invention;

FIGS. 10 to 12 show side elevations of further alternative bait holding apparatus according to the present invention;

FIGS. 13 to 15 show plan elevations of bait tying apparatus in accordance with the present invention;

FIG. 16 shows a plan elevation of a further alternative bait tying apparatus in accordance with the present invention; and

FIGS. 17 and 18 show plan elevations of two alternative bait applicator devices in accordance with the present invention.

### MODES FOR CARRYING OUT THE INVENTION

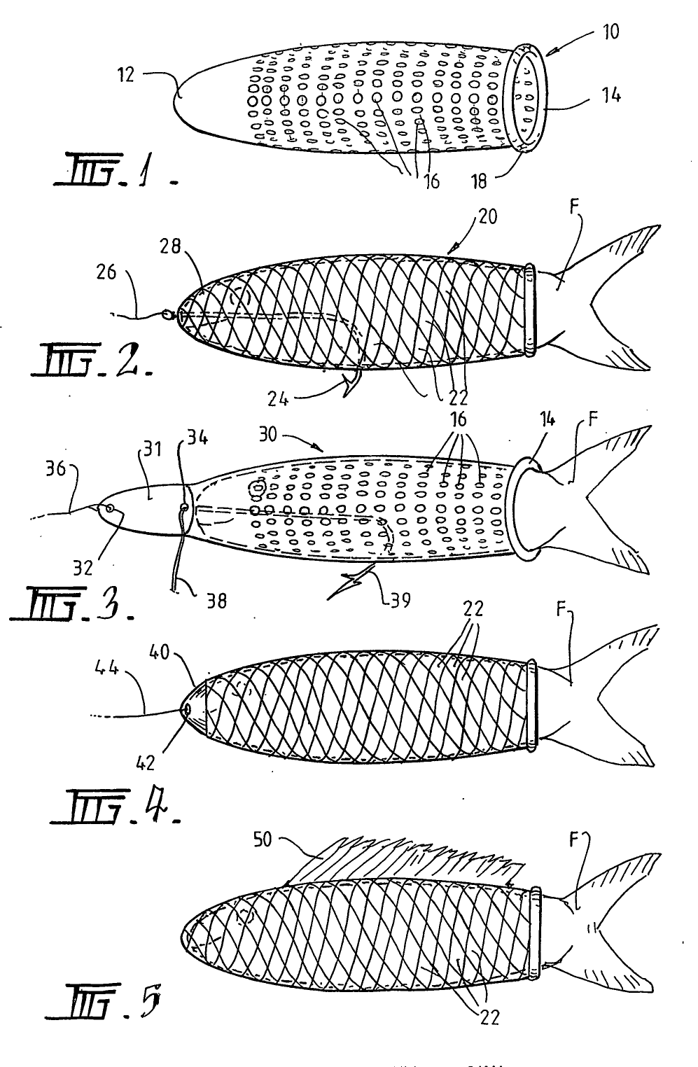

Referring firstly to FIG. 1, a bait holding apparatus is shown in the form of an elongate sock sleeve 10. The sock sleeve has a closed end 12 and an opposite open end 14. A plurality of apertures in the form of holes 16 are defined in the sock sleeve as shown.

The open end is typically reinforced by a circumferential back-fold or roll 18 of the sleeve 10. This allows for repeated insertion and removal of bait to and from the sleeve (eg. using an applicator as shown in FIGS. 17 and 18), without the sleeve deteriorating at that end (eg. by tearing). The closed end may also be reinforced, for example, by being of increased thickness (as specified during moulding) to prevent the bait from being pushed out at that end during insertion, and optionally to allow for line and hook attachment etc.

Typically the sock sleeve is formed from an elastomeric material having shape memory, such as an elastomeric polymer (eg. a natural or synthetic rubber such as latex, an ABS rubber etc). Thus, when a bait is inserted therein, the sleeve can expand and deform around the bait, thereby holding and reinforcing it and also providing structural integrity to the bait. The deformability of the sleeve also enables it to assume the general external shape of the bait, and this can be advantageous in visually attracting a predator.

Typically the sock sleeve 10 is formed by dipping an elongate mandrel into an elastomeric liquid polymer or monomer solution, allowing a skin to form around the mandrel, withdrawing the mandrel from the solution and allowing excess polymer to drip back into the solution. The polymer typically air cures on the external surface of the mandrel, and thereafter the sleeve can be slipped off the mandrel. The holes 16 can be formed eg. by pressing, cutting or punching either whilst the sleeve is on the mandrel, or once it has been removed. Alternatively, protrusions can be provided on the mandrel which define the holes. The open end of the sleeve is typically reinforced by folding or rolling that part of the sleeve at the open end circumferentially therearound to define a reinforcing section. This folding or rolling back is typically performed prior to complete curing of the end so that the folded back section fastens to the underlying sleeve.

Typically in use in an expanded orientation, the holes 16 are dilated, thereby providing a greater access to the bait held therewithin. Thus, bait fragments, bait aroma and smell, and bait visualisation can be provided to a predator (eg. to a larger fish such as a billfish). The apertures may also be of sufficient size for the predator to at least partially feed or nibble through the apertures thus further attracting them to the bait.

Typically the sock sleeve also has a shape approximating the bait prior to bait insertion. For example, the sock sleeve may have the general shape of a small fish.

Referring now to FIG. 2, a second sock sleeve 20 is shown with a bait such as a small fish F inserted therein. This sleeve is typically formed in a similar way to sock sleeve 10, but in this case the apertures are defined as diamond-shaped holes 22 through the sleeve, defining a grid-like formation of the sleeve around the fish. This exposes a greater proportion of the fish. However, in some applications a stronger sleeve material may be required and/or the user may need to be more careful when inserting bait into this sleeve. As shown, a hook 24 and line 26 can extend through and/or be mounted at closed end 28 of sleeve 20. Thus the apparatus can also function as a lure, snare or trap for the predator.

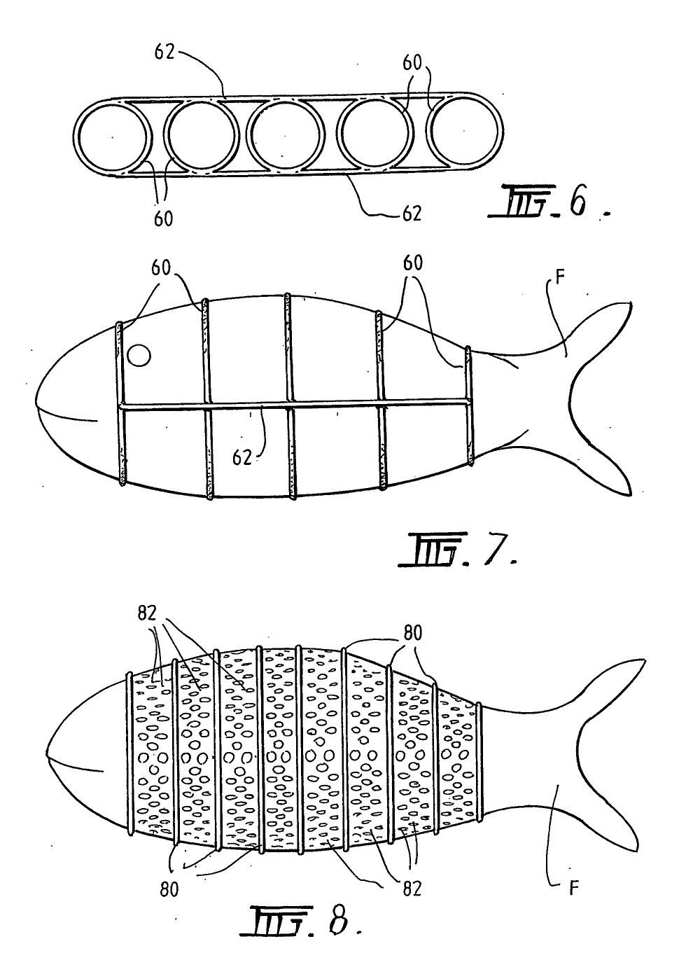

FIG. 3 shows a similar view to FIG. 1, but in this case the front (closed end) of the sock sleeve is modified. In this embodiment the closed end is formed to define a bill 31 through which holes 32,34 can be defined. The bill can have an aerodynamic profile to facilitate movement of the apparatus through air (when casting) and in water. This profile can also be shaped to cause an oscillating movement when the apparatus is moved through water, similar to a small fish swimming.

The leading hole 32 can have a line 36 attached thereto (such as a fishing line). The trailing hole 34 can have a connecting line 38 inserted therethrough, eg. for connecting that sleeve to another (optionally identical) adjacent sleeve. In this way, a plurality of sleeves can be joined together, where for example multiple teasers are required (such as with game and commercial fishing). A hook 39 can also or optionally be connected to bill 31 or to a line extending from hole 34 as shown.

FIG. 4 shows a sleeve similar to FIG. 2, but in this case the closed end 28 has a nose cone 40 formed thereat or adhesively fastened thereto. Again, the nose cone can have a hole 42 defined therethrough for connection to a line 44. The nose cone typically has a reflective outer surface, such as a coating with a reflective paint, or may even have a reflective material (eg. metallic material) dispersed therethrough. Such arrangements function to visually attract predators.

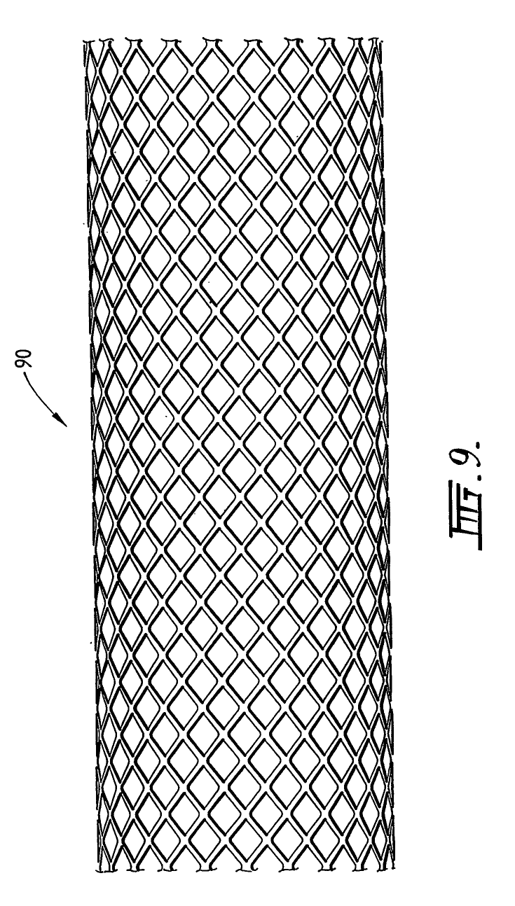

FIG. 5 shows a similar sleeve to FIG. 2, but in this case the sleeve has an artificial fin 50 attached thereto, to simulate the fin of a small fish, thereby acting as an attractor to a predator. In this regard, multiple fins can be mounted to the sleeve. Also, the fins can be fabricated from or include reflective or luminescent material to further attract a predator fish.

The apparatus of FIGS. 1 to 5 can also be fabricated from a non-deformable material, such as a perforated or apertured metal (eg. a stainless steel mesh having corrosion resistance). The advantage of using apertured metallic material such as mesh is that the life of the apparatus is increased.

In this case the mesh is shaped to be closely positioned to the bait (eg. a small fish) or has a small animal shape. In this regard, the non-deformable material is sized and then positioned to be in a close-facing relationship with the bait (eg. a small fish, rodent, piece of meat etc.) such that it preserves the structural integrity thereof whilst still acting as an attractor.

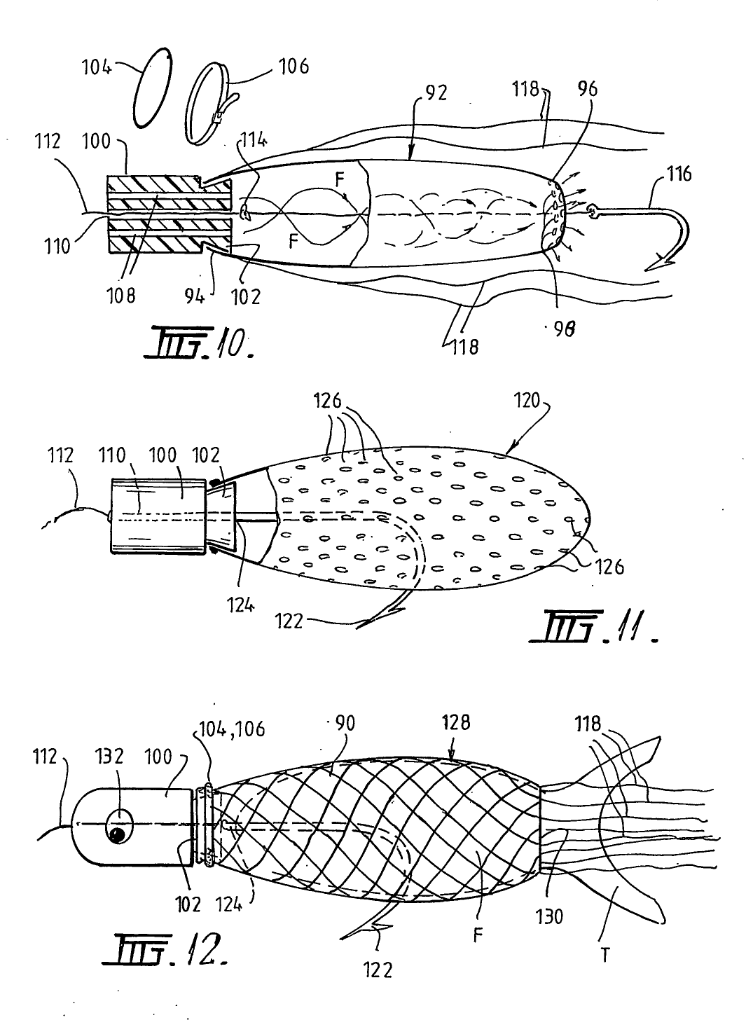

Referring now to FIGS. 6 and 7, an alternative embodiment of a bait holding apparatus is depicted. In this embodiment, a plurality of rings 60 are formed from a deformable elastomeric material and are joined together by opposite parallel linking members 62. The rings can be stretched around a fish F as shown in FIG. 7, and are held in place and prevented from spreading further apart by the linking members 62. At least one and typically two linking members 62 are employed.

The embodiment of FIG. 6 can be cut or pressed from a flat sheet of elastomeric material, and the rings then twisted into orientation when mounting the apparatus on a fish. Alternatively, the apparatus can be moulded (eg. in a die) using injection moulding etc.

Referring now to FIG. 8, a further alternative bait holding apparatus is depicted. In this case, the apparatus is formed from an apertured tape 80, typically having an adhesive on one side thereof. Tape 80 has a plurality of apertures 82 therethrough. The tape can be deformable in the sense that it can be formed from a polymer having elastic deformation and shape memory. Alternatively, the tape can be relatively inflexible. In any case, the tape is positionable around the bait in a close facing relationship that enhances the structural integrity thereof and/or that reinforces the bait.

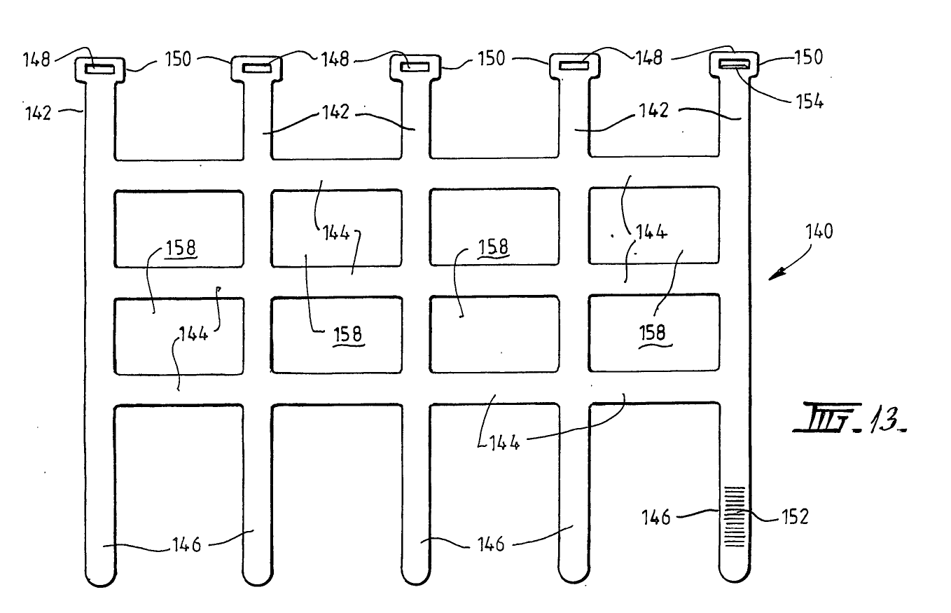

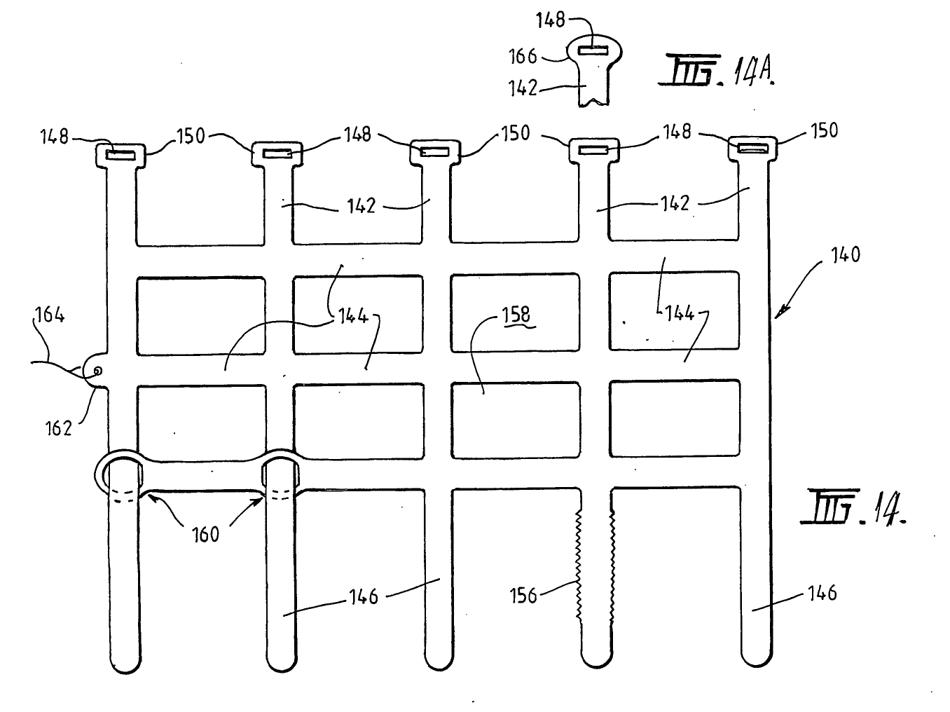

Referring now to FIG. 9, an apertured mesh 90 suitable for use with various apparatus according to the present invention is depicted. This mesh is typically polymeric or elastomeric, and is extruded as a continuous tubular length. The mesh can be cut and shaped as appropriate (e.g. to assume the external shape of the bait). The mesh can be used for forming the embodiments of FIGS. 2, 4 and 5. Alternatively, it can be closed at one end and releasably attached to a closure at the opposite end for use in a system as described, for example, in FIG. 10. Alternatively, the end opposite to the closure can be left open, as depicted in FIG. 12.

Referring now to FIG. 10, an alternative bait holding apparatus in accordance with the invention is depicted. In this embodiment, a receptacle in the form of elongate tubular bag 92 has an open end 94, and an opposing closed end 96. The bag can include a plurality of perforations, pores or apertures (as described above for the previous embodiments). However, in this embodiment a series of holes 98 are provided only at the closed end 96 as shown. The open end 94, which may be in the form of a circumferential skirt generally tapering inwardly, can be releasably mounted on a closure or bung in the form of a plug 100. The plug 100 has a circumferential recess 102 defined around one end thereof, into which the open end 94 can be received for releasable fastening therein. In this regard, an elastomeric O-ring 104, or a pull tie 106, can be positioned to surround the open end 94 when located in recess 102 and fasten it therein, to prevent its removal in use. The ring 104 can also be integrally formed with bag 92.

It will also be seen that the plug 100 has a plurality of passages 108 extending therethrough, and through which a fluid, such as water (or even a gas) can pass, to then flow into the interior of bag 92.

A central bore 110 is also defined through plug 100 and through which a line 112 (such as a fishing line) can be inserted. The fishing line can be provided with an appropriate stopper 114 (eg. a knot or tag) to prevent it from being pulled through bore 110. The line can also continue through the bag 92, such that the opposite end thereof passes out through one of the holes 98, for attachment to a fishing hook 116 or the like.

Optionally, a plurality of predator attracting filaments 118 (e.g. formed from a reflective material) can be fastened at one end between the O-ring 104 and the bag open end 94, or can be attached to the plug 100 itself.

In use of the apparatus of FIG. 10, a user reels in line 112, causing the apparatus to traverse through water. This causes the filaments 118 to flail in the water, thereby potentially attracting predators. Also, the water passes into the bag 92 interior via passages 108, and flows through the bag in a turbulent manner (e.g. as indicated by flow arrows F). Eventually, the water passes out of the bag closed end 96 via holes 98 as indicated.

When bait is located in the bag 92, the flow of water thereover entrains aroma, scent and particulate bait matter, acting as a further attractor to predators. This release can also occur when the bag is entirely perforated or apertured. One advantage of arrangement of FIG. 10, however, is that the outflow of water from the bag passes near hook 116 and a predator can thus be attracted to that end with the result that it can become hooked or snared at that end.

Thus, the apparatus of FIG. 10 can function as a lure. In addition, the filaments 118 can disguise the hook and the appearance of the bag, tricking the predator into believing that the apparatus is a live creature (eg. a squid or octopus). In this regard the plug 100 can also be styled aerodynamically and/or to have the shape of the head of a creature.

Again, the bag 92 can be shaped to have the outline of a whole animal bait. Advantageously, bait can be rapidly added to or removed from bag 92, simply by detaching the ring 104 or tie 106, thereby opening the bag end 94 and allowing rapid insertion of bait thereinto. Bait positionable in bag 92 can include whole bait, bait pieces or fragments, and even sponge material (e.g. artificial or natural sponge) soaked in fish oil, blood or other predatory attractor substance.

Referring now to FIG. 11, where like reference numerals are used to denote similar or like parts, the bag 92 can be replaced with a sleeve 120, not dissimilar to sock sleeve 10 of FIG. 1. In this embodiment, a hook 122 can also extend directly from plug 100 (e.g. being moulded such that its shank 124 is fastened therein). The sleeve 120 can have a plurality of apertures 126 formed therein for enabling bait held in the sleeve to be sensed by a predator. The sleeve also has a profile such that a whole live fish bait can be positioned therein, with the sleeve deforming around the fish bait or closely assuming its shape.

Referring now to the FIG. 12, where like reference numerals are used to denote similar or like parts, the sleeve 120 can be replaced with a mesh sleeve 128 (e.g. using the mesh 90 of FIG. 9, or a mesh similar to that shown in FIGS. 2, 4 and 5). In this embodiment, the tail T of fish F protrudes out beyond the open end 130 of the mesh sleeve, and a plurality of filaments 118 are attached to that open end. In addition, the design of a fish eye 132 has been printed or painted on plug 100, to further act as a predator attractor. This embodiment is in other respects similar to those described above.

Referring now to FIGS. 13 through to 15, where like reference numerals are used to denote similar or like parts, an alternative bait holder apparatus is shown in the form of tie grid system 140. The tie grid system includes a plurality of ties 142, which are connected to adjacent ties by transverse tie elements 144.

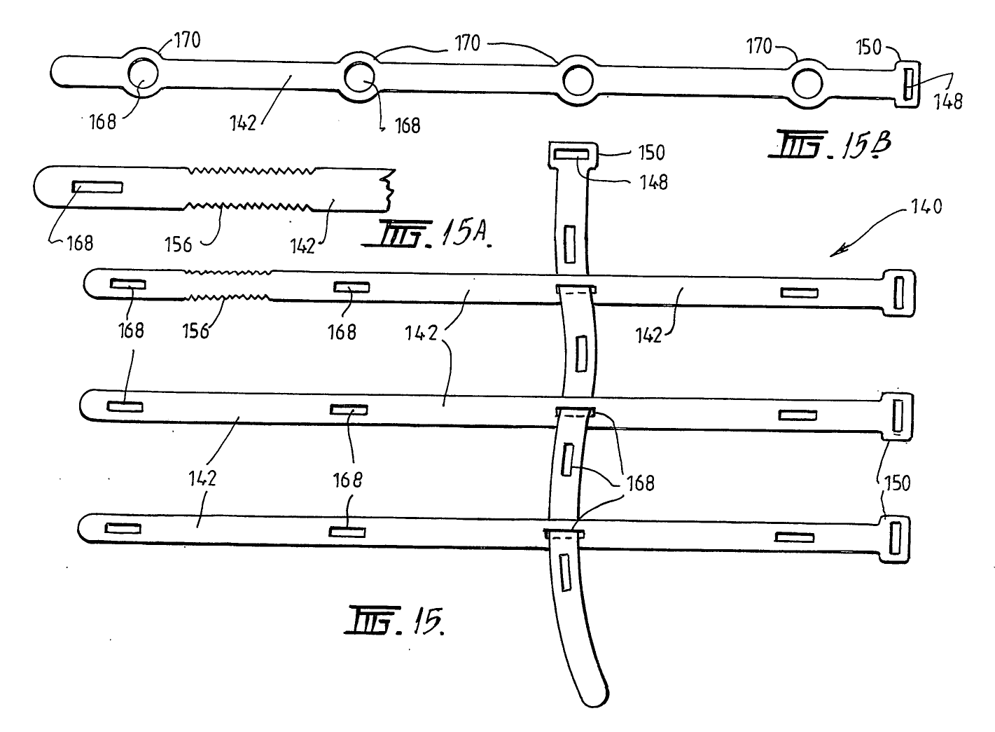

Each tie element has a free end 146, which can be inserted through the slot 148 of a head 150 located at the opposite tie end. Typically in this regard each free end is interferingly received in its respective slot (e.g. where transverse serrations 152 on free end 146 engage with protrusions 154 within the slot 148). However, the interfering fit can be via friction, via a push-fit, or via the engagement of side serrations 156 (see FIG. 14) with side walls of the slot 148.

In use of the tie grid system 140, a whole bait is typically positioned longitudinally across the system 140 (i.e. generally parallel to the tie elements 144), and then the opposite ends 146, 150 of the ties 142 are wrapped around the whole bait Free end 146 is then inserted through its respective slot and pulled tightly, binding the tie around the bait. This is repeated for each tie, until the bait is fastened therearound along its length by the system 140. Once so fastened, it will be seen that spaces 158 between adjacent ties 142 and tie elements 144 define apertures in the assembled configuration, which release bait scent, aroma, fragments etc and also enable a predator to nibble at the bait.

Referring now specifically to FIG. 14, it will be seen that instead of being integral with the ties 142, the tie elements can be joined to the ties via loops 160, through which the ties extend, and in which they can be interferingly received. An end tie can also be provided with a line loop 162 to which a line 164 can be attached, thus enabling the tie grid system to be dragged through water or fastened at a location, when wrapped around a bait.

As shown in FIG. 14A, instead of having a rectangular head 150, a rounded head 166 that is integral with the remainder of the tie 142 can be provided. The remaining features are as described above for FIG. 13.

Referring now specifically to FIG. 15, the tie grid system 140 can comprise a plurality of criss-crossing ties 142. In this embodiment, the ties can be joined to each other via tie slots 168. This joining can be facilitated by side serrations 156 shown in detail in FIG. 15A. FIG. 15B shows an alternative tie 142 wherein tie loops 170 are employed instead of tie slots.

The system of FIG. 15 can be wrapped around a bait in two directions, for example, where the bait is generally square or circular, such as a bait piece, rather than an elongate piece such as a whole bait (e.g. fish or rodent). The operation of the system of FIG. 15 is in other respects as described above for FIGS. 13 and 14.

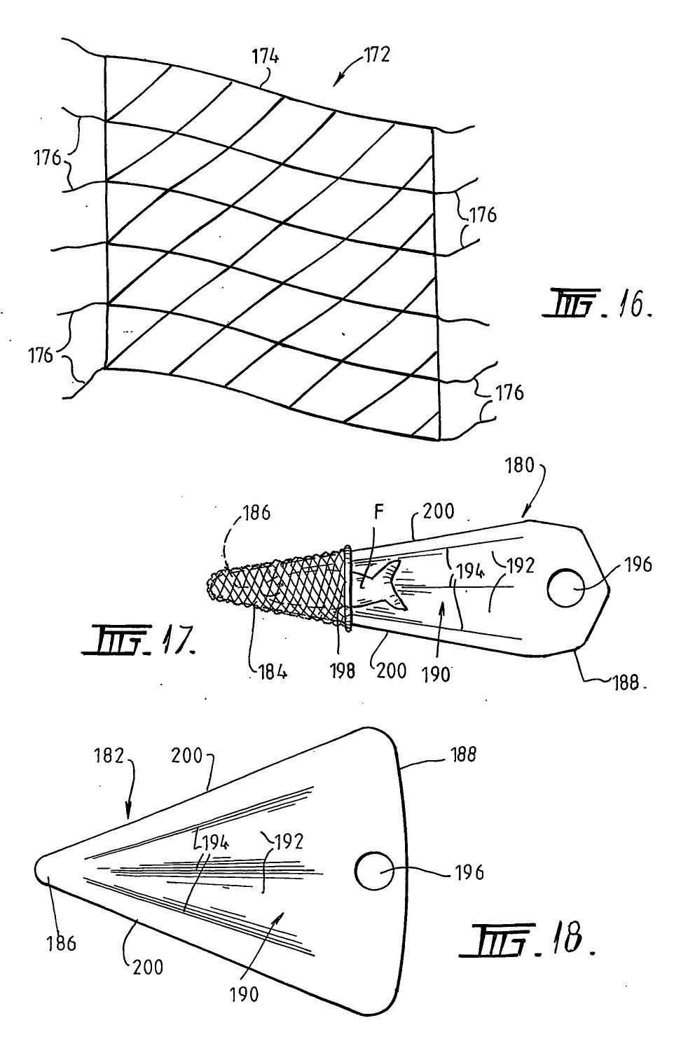

Referring now to FIG. 16, an alternative mesh tie system 172 is depicted. In this embodiment, a mesh 174 has a plurality of loose end ties 176 extending from opposite ends thereof. In a similar manner to the embodiments of FIGS. 13 to 15, the mesh can be wrapped around the bait, however, then the opposite end ties can be tied together by hand, or may be wound around each other (e.g. when formed from wire) and/or optionally seal fastened therearound. The loose end ties can also be replaced with ties similar to those used in the embodiments of FIGS. 13 to 15 (i.e. ties that extend out from the mesh).

Typically the loose end ties and the mesh are formed from a deformable elastomeric polymeric material, generally having a circular cross section, to provide strength and ease of use.

Referring now to FIGS. 17 and 18, where like reference numerals are used to denote similar or like parts, bait applicators 180 and 182 are depicted. The bait applicator 182 in FIG. 18 is wider than the bait applicator 180 in FIG. 17, but its principles of operation is identical, and its construction is similar. The bait applicators can be used to insert bait into any of the apparatus depicted in FIGS. 1 to 5 and 9 to 12. Indeed, in FIG. 17 the applicator is shown inserted into a mesh sleeve 184, similar to that shown in FIG. 2.

Each bait applicator has a relatively narrower insertion end 186, and an opposing relatively wider grip end 188. Each applicator has a generally planar surface 190 (typically on either side of the applicator) and extending between the insertion end and the grip end. However, the surface 190 can also be concave to further assist bait insertion, the concave surface defining an elongate channel extending between the insertion end 186 and grip end 188.

The surface 190 can be provided with channels 192, defined by ribs 194 that extend longitudinally from the grip end to the insertion end. The channels facilitate the easy sliding of a bait, such as a whole fish F (as shown in FIG. 17) across the applicator surface, helping to guide it towards the insertion end.

The grip end of each applicator is provided with a finger hole 196 to aid in user handling of the applicator, especially during applicator insertion and then bait insertion. Using the finger hole 196 the applicator can also be hung on a hook for storage.

In use, the applicator is inserted into the open end 198 of mesh sleeve 184, and the tapering sides 200 of the applicator eventually engage the open end 198 and cause it to expand or dilate. A bait (e.g. fish F) can then be placed on surface 190 and be slid along the applicator, riding in channels 192 as guided by ribs 194. The fish F then passes in through the expanded open end 198 of the mesh sleeve, and eventually the desired length of insertion of the bait is achieved. The bait and mesh sleeve can then be gripped with one hand with the applicator withdrawn by the opposite hand (e.g. as facilitated by the user inserting their finger through hole 196).

The applicator enhances the baiting of the various sleeves described above. The applicator can be provided with a plurality of finger holes 196 as appropriate. The applicator may take other shapes as appropriate, provided that it opens the bait insertion end of the receptacle into which it is to be inserted, and provides a guiding surface for inserting the base into the receptacle. Typically the applicator is injection moulded from a plastics material.

The apparatus described above can readily be modified to accommodate different bait types, including other sea creatures (such as prawns and mussels), rodents such as rats and mice for land-base hunting and trapping, and even portions or slabs of raw meat, burley, bread and meal etc. The reinforced bait can be used to attach a wide range of predators including fish, shark, feral animals such as wild dog, cat, pigs etc.; pests such as excessive kangaroo populations; bear etc.

A number of advantages follow on from the embodiments as described herein.

These include:
The apparatus helps keep a fish bait, or other baiting substance, in one piece during extended use.
The apparatus significantly decreases the time required to house or reinforce a bait, such as a fish bait.
A deformable apparatus can be easily and rapidly positioned on and removed from a bait to which it is attached, also making it available for reuse.
The apparatus can be made from a transparent material such that its presence is more difficult to detect by a predator, or it may be made from or have dispersed therethrough a predator attractor material, such as a reflective or luminescent material.
Various attachments can be formed on the apparatus, including bills, cones, fins, hooks etc.
The apparatus can be used for fishing, hunting, trapping etc.
The apparatus can be used in trawling, trolling, game fishing, beach fishing, boat fishing, rock fishing etc.
Various hooking systems can be incorporated into the apparatus.
The apparatus can also prevent bait from coming off a hook.
The apparatus can preserve the natural look and shape of the bait to which it is attached.
When used on fish or other whole animal bait, the apparatus holds the skin intact, even where it is subjected to nibbling or biting.
Natural secretions from the bait in the apparatus are released through the apertures, acting as a natural attractant for a predator.

Whilst the invention has been described with reference to a number of preferred embodiments, it should be appreciated that the invention can be embodied in many other forms.

1-44. (canceled)

45-99. (canceled)

100. A bait holding apparatus comprising:
a resiliently deformable receptacle having an open end and an opposing closed end, the bait being insertable into the receptacle through the open end and, once inserted, the receptacle being resiliently deformable around the bait, the receptacle extending seamlessly around the closed end and lateral side(s) thereof; and
a plurality of apertures defined in the receptacle such that, when the bait is placed therein, the predator can sense the bait via the apertures.

101. The apparatus as claimed in claim 100 wherein the receptacle is an enlongate sleeve into which the bait can be inserted.

102. The apparatus as claimed in claim 100 wherein the open end is reinforced.

103. The apparatus as claimed in claim 100 wherein the apertures are a plurality of holes formed in the receptacle to define a perforated or grid-like formation around the bait in use.

104. The apparatus as claimed in claim 100 wherein the closed end is adapted to provide a line attachment point thereto.

105. The apparatus as claimed in claim 100 wherein the closed end has an aerodynamic profile to enhance movement of the apparatus through a fluid such as water.

106. A bait holding apparatus comprising a plurality of rings in series through each of which the bait can be inserted, with each ring connected to a next adjacent ring by one or more connecting members.

107. The apparatus as claimed in claim 106 wherein each ring is deformable and defines part of a lateral side of the receptacle.

108. The apparatus as claimed in claim 106 wherein bait is inserted to extend through each of the rings in series.

109. The apparatus as claimed in claim 106 wherein two connecting members maintain adjacent rings in spaced relation to each other.

110. The apparatus as claimed in claim 106 wherein the receptacle or each of the rings is formed from an elastomeric material having shape memory.

111. A method for forming an apparatus as defined in claim 100 comprising the steps of:
dipping a mandrel into molten material for the receptacle;
removing the mandrel and allowing the receptacle to solidify around the mandrel; and
forming a plurality of apertures in the receptacle, either whilst on the mandrel, or once removed therefrom.

112. The method as claimed in claim 111 wherein the apertures are formed in the sleeve by pressing, punching or cutting.

113. The method for forming an apparatus as defined in claim 106 comprising the steps of:
arranging a sheet of deformable material on a substrate; and
forming in and then removing from the sheet a plurality of adjacent but non-overlapping rings, and such that at least one connecting member extends between adjacent rings.

114. The method as claimed in claim 113 wherein the rings and connecting member {s} are formed by pressing, punching or cutting the sheet.

115. The method as claimed in claim 113 wherein two connecting members arc defined to extend between adjacent rings, one being tangential to an upper part of each ring and the other being tangential to a lower part of each ring.

116. A bait holding apparatus formed from a material having a plurality of apertures therethrough that has a shape that enables it to be positioned to surround the bait in a close-facing relationship, in a manner that tends to preserve the structural integrity of the bait, wherein the apparatus is chosen from a group consisting of:
a resiliently deformable receptacle having an open end and an opposing closed end, the bait being insertable into the receptacle through the open end and, once inserted, the receptacle being resiliently deformable around the bait, the receptacle extending seamlessly around the closed end and lateral side(s) thereof; and
a plurality of apertures defined in the receptacle such that, when the bait is placed therein, the predator can sense the bait via the apertures,
a metallic mesh receptacle, and
one or more ties or tapes having apertures therethrough and which can be wrapped around the bait in the close-facing relationship.

117. The apparatus as claimed in claim 116 wherein the metallic mesh is a perforated or apertured stainless steel mesh.

118. The apparatus as claimed in claim 116 wherein the ties or tapes are arranged in a grid formation for wrapping around the bait, the grid defining the apertures therethrough, with free ends of the ties or tapes being fastenable together to define the receptacle.

119. A bait holding apparatus comprising:
a receptacle in which the bait can be held and including an opening through which the bait can be introduced into the receptacle; and
a closure for the receptacle opening and about which the receptacle can be releasably attached to close the opening.

120. The apparatus as claimed in claim 119 wherein the closure has one or more passages extending therethrough such that fluid can flow from the apparatus exterior and into the receptacle interior.

121. The apparatus as claimed in claim 119 wherein the closure is a bung having a peripheral recess defined at one end thereof into which a skirt portion of the receptacle opening can be releasably fastened.

122. The apparatus as claimed in claim 121 wherein the skirt portion is retained in the recess by a tie or ring extending circumferentially therearound.

123. The apparatus as claimed in claim 119 further comprising an attractor device associated with the closure.

124. The apparatus as claimed in claim 123, wherein the attractor device includes filaments attached to the closure, coloring of the closure, reflective material at or dispersed through the closure, or shaping of the closure.

125. The apparatus as claimed in claim 119 wherein the receptacle is resiliently deformable and has an open end and an opposing closed end, the bait being insertable into the receptacle through the open end and, once inserted, the receptacle being resiliently deformable around the bait, the receptacle extending seamlessly around the closed end and lateral side(s) thereof.

126. A bait holding apparatus comprising:
a receptacle in which the bait can be held and including an opening through which the bait can be introduced into the receptacle; and
a closure for the receptacle opening and having one or more passages extending therethrough such that fluid can flow from the apparatus exterior and into the receptacle interior.

127. The apparatus as claimed in claim 126 wherein the receptacle is resiliently deformable and has an open end and an opposing closed end, the bait being insertable into the receptacle through the open end and, once inserted, the receptacle being resiliently deformable around the bait, the receptacle extending seamlessly around the closed end and lateral side(s) thereof and the closure has one or more passages extending therethrough such that fluid can flow from the apparatus exterior and into the receptacle interior.

128. A bait holding apparatus comprising a plurality of ties, each tie connected to one or two adjacent ties and each having a fastening mechanism associated with opposite ends thereof such that each tie can be wrapped around the bait and fastened at or near its ends.

129. The apparatus as claimed in claim 128 wherein each tie is connected to one or two adjacent ties by one or more transversally extending ties to define a tie grid.

130. The apparatus as claimed in claim 129 wherein each transversally extending tie is insertable through a respective slot in each of the plurality of ties.

131. The apparatus as claimed in claim 130 wherein each transversally extending tie is interferingly receivable in its respective slot in each of the plurality of ties.

132. The apparatus as claimed in claim 128 wherein the fastening mechanism is chosen from the group consisting of:
free tie ends that can be tied together to fasten the apparatus to the bait and
a slotted head at one tie end and a free end at the other tie end that is receivable interferingly through the slot of its head to fasten the apparatus to the bait.

133. The apparatus as claimed in claim 130, wherein sides of the other tie free end, or of each transversally extending tie, are serrated.

134. The apparatus as claimed in claim 128 wherein each tie is a flat tape-like member, or is generally circular in cross-section.

135. The apparatus as claimed in claim 128 wherein each tie is formed from an elastomeric material.

136. An applicator for a bait holding apparatus that has a deformable opening to a receptacle, the applicator also being suitable for an apparatus as defined in claim 100, the applicator comprising a receptacle insertion end adapted for insertion into the opening of the receptacle to deformably open the same to facilitate bait insertion, and a bait guiding surface extending from the insertion end and over which the bait can be moved, with the bait guiding surface extending towards an applicator remote end for protruding beyond the receptacle when the applicator is inserted in the receptacle opening to facilitate applicator handling by a user.

137. An applicator as claimed in claim 136 that is generally flat and, in plan view, that gradually tapers from a relatively wider remote end to a relatively narrower insertion end, with the bait guiding surface being defined on both sides of the applicator.

138. The applicator as claimed in claim 136 wherein one or more guide channels arc provided on the bait guiding surface to facilitate guidance of the bait towards and in through the receptacle opening.

139. The applicator as claimed in claim 136 wherein one or more finger holes are provided at the remote end to facilitate user handling of the applicator.

140. An applicator as claimed in claim 136 that has a concave guiding surface, defining an elongate channel extending between the insertion and remote ends.

141. The apparatus as claimed in claim 126, wherein the receptacle is resiliently deformable and has an open end and an opposing closed end, the bait being insertable into the receptacle through the open end and, once inserted, the receptacle being resiliently deformable around the bait, the receptacle extending seamlessly around the closed end and lateral side(s) thereof and the closure is a bung having a peripheral recess defined at one end thereof into which a skirt portion of the receptacle opening can be releasably fastened.

142. Apparatus as claimed in claim 126, wherein the receptacle is resiliently deformable and has an open end and an opposing closed end, the bait being insertable into the receptacle through the open end and, once inserted, the receptacle being resiliently deformable around the bait, the receptacle extending seamlessly around the closed end and lateral side(s) thereof and the apparatus further includes an attractor device associated with the closure chosen from the group consisting of filaments attached to the closure, coloring of the closure, reflective material at or dispersed through the closure, and shaping of the closure.

143. The apparatus as claimed in claim 132, wherein sides of the other tie free end, or of each transversally extending tie, are serrated.
